(19) United States
(12) Patent Application Publication
(10) Pub. No.: US 2025/0026254 A1
(43) Pub. Date: Jan. 23, 2025

(54) SEAT FASTENER AND INCORPORATION METHOD

(71) Applicant: YKK CORPORATION, Tokyo (JP)

(72) Inventors: Yuya Takahashi, Tokyo (JP); Takefumi Adachi, Tokyo (JP)

(21) Appl. No.: 18/776,351

(22) Filed: Jul. 18, 2024

(30) Foreign Application Priority Data
Jul. 19, 2023 (JP) 2023-117397

(51) Int. Cl. B60N 2/58

(52) U.S. Cl. CPC B60N 2/5825

(57) ABSTRACT

A seat fastener is long and configured to fasten a cover material to a cover material. The seat fastener includes a female member configured to be fixed to the cover material and the male member configured to be fixed to the cover material. The female member includes a main piece and an engagement portion formed inside the main piece to be engageable with the male member. In an engaged state in which the male member is engaged with the engagement portion, the main piece is located to cover at least a part of the male member from outside and is exposed outside with respect to the cover materials between respective fixation positions to the cover materials.

### CROSS REFERENCE TO RELATED APPLICATIONS

The entire disclosure of Japanese Patent Application No. 2023-117397 filed Jul. 19, 2023 is expressly incorporated by reference herein.

### TECHNICAL FIELD

The present invention relates to a seat fastener that fastens adjacent seat members for an automobile seat or the like and an incorporation method.

### BACKGROUND ART

Parts of an automobile seat or the like typically include a cover member or a seat member such as a cover material, which covers a surface of a cushion body formed from a synthetic resin foam material. Peripheral portions (seat peripheries) of such seat members are fastened to each other using a seat fastener described, for instance, in Document 1 (JP 7191490 B) or Document 2 (JP 5514901 B).

The seat fastener described in Document 1 includes a first fastening member fixed to a peripheral portion of a first seat member and a second fastening member fixed to a peripheral portion of a second seat member and the first fastening member and the second fastening member are to be engaged with each other. In this seat fastener, in a state where the first fastening member is engaged with the second fastening member, a fixation portion of the second fastening member that is fixed to the second seat member is located closer to the first seat member than respective engagement portions of the first fastening member and the second fastening member. Both of the first fastening member and the second fastening member are thus covered and hidden by the first seat member and the second seat member so that the seat fastener is not exposed outside.

The seat fastener described in Document 2 includes a first member to which one seat periphery is fixed and a second member to which the other seat periphery is fixed and the first member and the second member are to be engaged with each other. In a state where the second member and the first member of the seat fastener are engaged with each other, a fixation portion of the other seat periphery fixed to the second member is located closer to the one seat periphery than the first member and the second member. Both the first member and the second member are thus covered by the one seat periphery and the other seat periphery so that the seat fastener is not exposed outside.

Similar to the seat fasteners described in Documents 1 and 2, a typical seat fastener is a member that is covered by peripheral portions of a pair of seat members so as not to be exposed outside. That is, the seat faster is normally not configured as a member intended to be exposed outside.

However, there may be a demand that a portion between the peripheral portions of the pair of seat members is decorated, and the seat fasteners not exposed outside as described in Documents 1 and 2 are unsuitable for the use.

### SUMMARY OF THE INVENTION

An object of the invention is to provide a seat fastener enabling a portion between a pair of seat members to be decorated and an incorporation method.

(1) According to an aspect of the invention, there is provided a long seat fastener configured to fasten a second seat member to a first seat member, the seat fastener including: a female member configured to be fixed to the first seat member; and a male member configured to be fixed to the second seat member, in which the female member includes: a main piece; and an engagement portion formed inside the main piece to be engageable with the male member, and in an engaged state in which the male member is engaged with the engagement portion, the main piece is located to cover at least a part of the male member from outside and is exposed outside with respect to the first seat member and the second seat member between respective fixation positions to the first seat member and the second seat member.

In the seat fastener according to the aspect of the invention, the second seat member is fastened to the first seat member by engaging the male member with the engagement portion of the female member. At this time, the main piece of the female member is located to cover at least a part of the male member in the engaged state, and the female member is at least partially exposed outside with respect to the first seat member and the second seat member between the above fixation positions. It is thus possible to decorate, as a decorative portion, at least the exposed main piece between the first seat member and the second seat member.

In addition, since it is not necessary to use any other member than the seat fastener for decoration, it is possible to eliminate concerns about an increase in cost due to the addition of any other member and complication of an effort for incorporation.

(2) In the seat fastener of the aspect of the invention, the main piece may include a fixation portion configured to be fixed to the first seat member; and an extension extending continuously from the fixation portion, the extension may have a housing space defined inside thereof, opposite a surface exposed outside, to house a part of the male member, and the engagement portion may be formed in the housing space.

In such a configuration, at least a part of the male member engaged with the engagement portion formed in the housing space is covered from outside by the extension, which makes it possible to decorate, the extension as the decorative portion, between the first seat member and the second seat member.

(3) In the seat fastener of the aspect of the invention, an outer surface of the extension may be at least partially curved.

Such a configuration provides a comfortable feel of touch and improves the flexibility of the seat fastener itself as compared with, for instance, a case where the portion continuous with the fixation portion is in a cornered shape such as a U-shape. Further, even though a fastened portion is in a curved shape, the seat fastener is easily deformable in a curve to be fixed. It is thus possible to eliminate the necessity of a plurality of slits or the like, along a width direction orthogonal to a longitudinal direction of the seat fastener, that may otherwise be provided to improve the flexibility of the seat fastener.

(4) In the seat fastener of the aspect of the invention, the engagement portion may include an engagement piece projecting from an inner side of the extension toward the housing space, the extension may include a projecting portion that extends closer to the fixation position to the second seat member with respect to a continuous portion with the engagement portion, and a distal end of the projecting portion may be in contact with the second seat member in the engaged state.

Such a configuration allows the male member to be broadly covered by the extension with the distal end of the projecting portion being in contact with the second sheet member in the engaged state of the female member and the male member. The design of appearance can thus be improved.

In addition, the distal end of the projecting portion is in contact with the second sheet member, making it possible to stabilize the engaged state of the female member and the male member.

(5) In the seat fastener of the aspect of the invention, the engagement portion may include an engagement piece projecting from an inner side of the extension toward the housing space, the male member may include an engaged portion configured to be engaged with a distal end of the engagement piece, the fixation portion may include a receiving portion continuous with a portion opposite a continuous portion with the extension, and the receiving portion may be configured to receive the male member in the engaged state at a side opposite the engaged portion.

In such a configuration, the engagement piece is temporarily deformed and bent as the male member is inserted into the female member while being received by the receiving portion. This facilitates engagement of the engaged portion of the male member with the distal end of the engagement piece.

Meanwhile, in the engaged state, the engagement piece may function as a “barb” to prevent the male member from being pulled out of the female member. Further, even when the male member is attempted to be pulled out of the female member, force causing the distal end to approach the male member may act on the engagement piece. This may narrow a distance between the engagement piece and the receiving portion and further enhance the engagement strength.

(6) In the seat fastener of the aspect of the invention, the engagement portion may include: an engagement piece projecting from an inner side of the extension; and an engagement projection continuous with the fixation portion, the engagement projection being located at a position facing the engagement piece, and the male member may include a pair of engaged portions configured to be engaged with the engagement piece and the engagement projection.

The engagement strength is improvable by the engagement of the pair of engaged portions of the male member with the engagement piece and the engagement projection.

(7) In the seat fastener of the aspect of the invention, the male member may include: a male member body that is long and flexible and that includes an engaged portion configured to be engaged with the engagement portion; and a tape member attached to the male member body, and a thickness of the male member body, excluding the engaged portion, in a thickness direction orthogonal to a longitudinal direction of the male member body may be smaller than a width of the male member body in a width direction orthogonal to the longitudinal direction and the thickness direction.

The male member body is thus formed to have substantially a flat shape, and the male member body formed, for instance, from a rigid resin can have flexibility. In addition, the tape member attached to the male member body is easily fixable to the second sheet member by being sewed or the like onto its exterior side. The tape member fixed may be prevented from being exposed on the exterior side by folding the portion of the second sheet member to which the tape member is fixed.

(8) In the seat fastener of the aspect of the invention, the female member may be formed from a softer material than the male member.

In such a configuration, the flexibility of the seat fastener as a whole may be improved by forming the female member from a soft material while the engagement strength between the male member and the engagement portion is maintained.

(9) According to another aspect of the invention, there is provided an incorporation method of fastening a second seat member to a first seat member using a long seat fastener, the seat fastener including: a female member including a main piece and an engagement portion formed inside the main piece; and a male member engageable with the engagement portion, the method including: fixing the female member to the first seat member and fixing the male member to the second seat member; and engaging the male member with the engagement portion, in which, in an engaged state in which the male member is engaged with the engagement portion, the main piece is located to cover at least a part of the male member from outside and is exposed outside with respect to the first seat member and the second seat member between respective fixation positions to the first seat member and the second seat member.

According to the incorporation method of the another aspect of the invention, it is possible to provide an incorporation method that may achieve workings and effects similar to those of the seat fastener of the aspect of the invention.

According to the aspects of the invention, there can be provided a seat fastener enabling a portion between a pair of seat members to be decorated and an incorporation method.

### BRIEF DESCRIPTION OF DRAWINGS

FIG. 1 is a schematic explanatory diagram illustrating an automobile seat provided with a seat fastener according to an exemplary embodiment of the invention.

FIG. 2 is a cross sectional view taken along a line II-II in FIG. 1, illustrating a coupled state of the seat fastener according to the exemplary embodiment.

FIG. 3 is a cross-sectional view of a male member of the seat fastener according to the exemplary embodiment.

FIG. 4 is a cross-sectional view of a female member of the seat fastener according to the exemplary embodiment.

FIG. 5 is an explanatory diagram illustrating an incorporation procedure using the seat fastener according to the exemplary embodiment.

FIG. 6 is an explanatory diagram illustrating a modification example of the seat fastener according to the exemplary embodiment.

### DETAILED DESCRIPTION

### Configuration of the Exemplary Embodiment

Referring to the drawings, an exemplary embodiment of the invention will be described below.

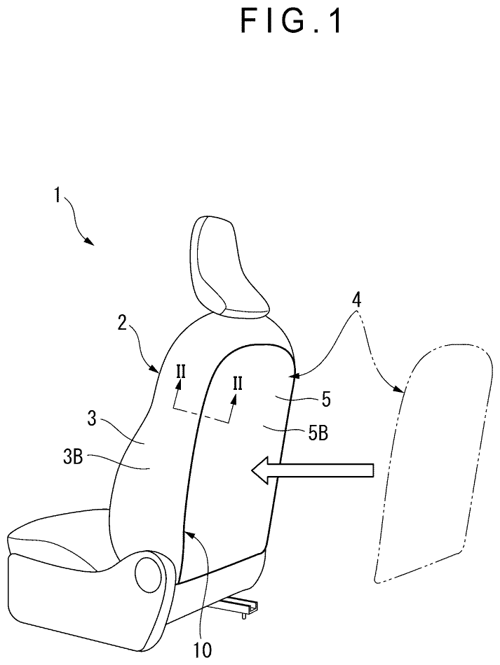

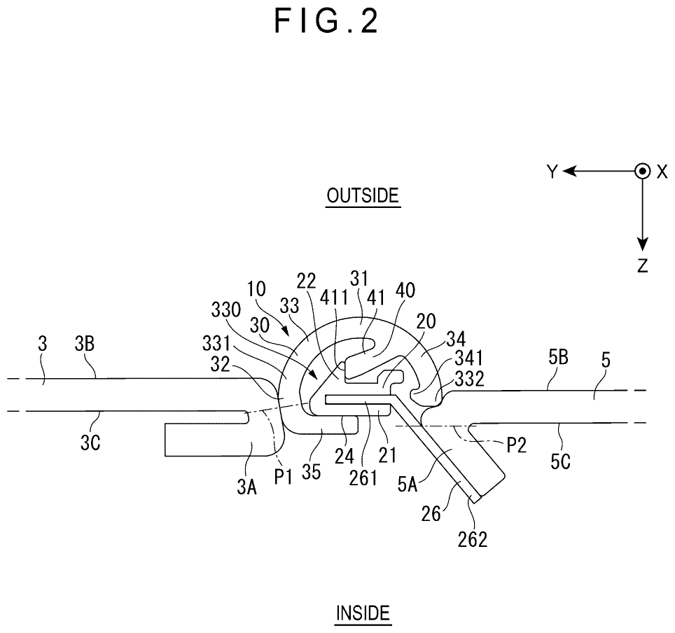

Referring to FIG. 1 and FIG. 2, a seat fastener 10 according to the exemplary embodiment is configured to fasten, to a cover material 3 (a body cover material) covering a seat body 2 of an automobile seat 1, a cover material 5 (a panel cover material) covering a back panel 4 of the automobile seat 1. The automobile seat 1 is a seat for an automotive vehicle. The cover material 3 corresponds to a first seat member. The seat fastener 10 includes a male member 20 (an inner member) that is to be fixed to a peripheral portion 5A of the cover material 5 and a female member 30 (an outer member) 5 that is to be fixed along a peripheral portion 3A of the cover material 3. It should be noted that the back panel 4 in the exemplary embodiment is provided by a soft back panel softer than a typical back type and is an independent component separate from the seat body 2.

Hereinbelow, a longitudinal direction (front-rear direction) of the seat fastener 10 is defined as an X-axis direction, a width direction (right-left direction) of the seat fastener 10 is defined as a Y-axis direction, and a thickness direction (exterior-interior direction) of the seat fastener 10 is defined as a Z-axis direction. The X-, Y-, and Z-axis directions are orthogonal to one another.

Each of the male member 20 and the female member 30 is formed continuously in the X-axis direction to have the same cross-sectional shape in a plane orthogonal to the X-axis direction, for instance, a plurality of intermittent slits along the Y-axis direction are not provided. The female member 30 is formed from a softer material than the male member 20. The male member 20 and the female member 30 may be formed from the same material or the male member 20 may be formed from a softer material than the female member 30.

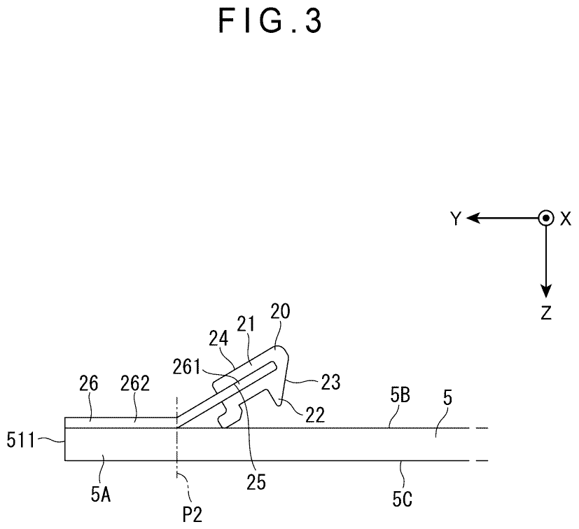

As illustrated in FIG. 2 and FIG. 3, the male member 20 includes a flexible male member body 21 elongated in the X-axis direction, and a flexible tape member 26 elongated in the X-axis direction and attached to the male member body 21. A variety of flexible members are usable as the tape member 26 and, in the exemplary embodiment, unwoven fabric is used.

The male member body 21 includes an engaged portion 22 located to project toward a later-described extension 33 in an engaged state of the male member 20 and the female member 30, an inclined surface 23 obliquely inclined from a distal end of the male member body 21 to the engaged portion 22, and a received surface 24 that is continuous with the inclined surface 23 at the distal end of the male member body 21 and is formed to extend along the Y-axis direction in the engaged state. The received surface 24 includes a flat surface along a surface of the tape member 26 in the exemplary embodiment. The male member body 21 includes a groove 25 that opens on a rear-end side (a side close to the cover material 5) thereof and to which the tape member 26 is secured. A thickness of the male member body 21, excluding the engaged portion 22, in the Z-axis direction is smaller than a width thereof in the Y-axis direction. The male member body 21 is thus in a flat and bendable shape in the Y-axis direction as a whole in the exemplary embodiment.

The tape member 26 includes a secured portion 261 secured in a state of being inserted in the groove 25 of the male member body 21 and an extended portion 262 that is continuous with the secured portion 261 and extends from the rear-end side (the side close to the cover material 5) of the male member body 21. The tape member 26 is fixed at a fixation position P2 by sewing a part of the extended portion 262 spaced from the male member body 21 at a predetermined distance along the peripheral portion 5A of the cover material 5.

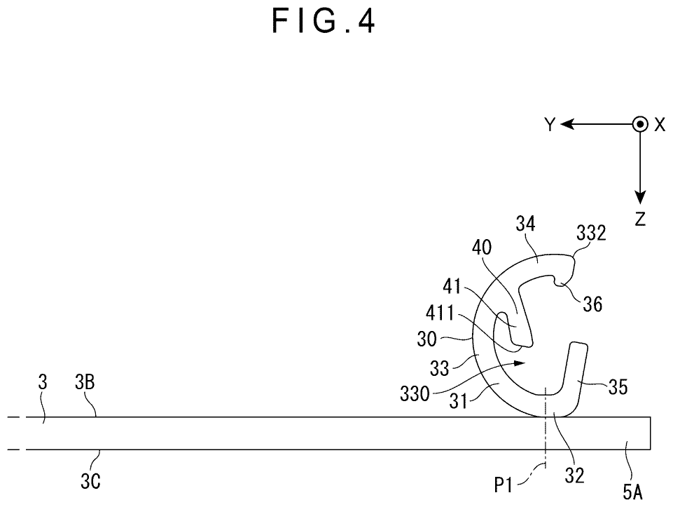

As illustrated in FIG. 2 and FIG. 4, the female member 30 includes a main piece 31 located to cover at least a part of the male member 20 in the engaged state, in the exemplary embodiment, a part of the male member body 21 and the tape member 26, from outside (from an exterior side of the cover materials 3 and 5) and an engagement portion 40 formed on an inner side of the main piece 31 (on an interior side of the cover materials 3 and 5).

The main piece 31 includes a fixation portion 32 that is to be fixed at a fixation position P1 by being sewed along the peripheral portion 3A of the cover material, the extension 33 that extends continuously from the fixation portion 32 and has a curved shape in cross section, and a receiving portion 35 that is continuous with the fixation portion 32 and receives the received surface 24 of the male member 20. An engagement portion 40 is provided on an inner side of the extension 33.

The extension 33 is formed to curve in an arc that is convex outward in the Z-axis direction, and a base end 331 of the extension 33 is continuous with the fixation portion 32. The extension 33 includes a projecting portion 34 near a distal end 332 thereof. The projecting portion 34 is located closer to the cover material 5 than a continuous portion with the engagement portion 40 in the engaged state. The thus-formed extension 33 has an outer surface that is at least partially curved, defining a housing space 330 inside thereof, opposite a surface exposed outside. The housing space 330 houses at least a part of the male member 20. The engagement portion 40 is formed in the housing space 330. The extension 33 is located on an exterior side with respect to the fixation portion 32 in the engaged state. The fixation portion 32 includes a portion that flatly extends from the base end 331 of the extension 33 to a small extent in the exemplary embodiment. The shape of the fixation portion 32 is not limited thereto. The fixation portion 32 may be formed, for instance, in a curve along the curved shape of the extension 33.

The projecting portion 34 is formed to extend from the continuous portion with the engagement portion 40 in a branched manner. In the engaged state of the male member 20 and the female member 30, the projecting portion 34 is located closer to the cover material 5 than the continuous portion as described above and the distal end 332 thereof is in contact with a first surface 5B of the cover material 5. It should be noted that the projecting portion 34, which also forms a part of the extension 33, is in a curved shape in cross section. In addition, a guide projection 341 projecting inward is formed at the distal end 332 of the projecting portion 34. The guide projection 341 guides the inclined surface 23 (see FIG. 3) of the male member 20 toward the fixation portion 32 during insertion of the male member 20 into the female member 30.

The receiving portion 35 is continuous with a portion of the fixation portion 32 opposite the continuous portion between the fixation portion 32 and the extension 33. The receiving portion 35 extends from a side close to the fixation portion 32 toward a side close to the distal end 332. Further, the receiving portion 35 projects in a direction toward the projecting portion 34 and is located at a position below a position of a lower end of the projecting portion 34 in the Z-axis direction. An entrance of the housing space 330 is formed between the receiving portion 35 and the projecting portion 34 and the entrance is an opening narrower than the inside of the housing space 330. In the engaged state, the receiving portion 35 is located along the Y-axis direction and opposed to the extension 33 in the exterior-interior direction of the seat fastener 10 (the Z-axis direction in the exemplary embodiment), while receiving the male member 20 in the engaged state at a side opposite the engaged portion 22 in the Z-axis direction.

The engagement portion 40 includes an engagement piece 41 projecting from the inner side of the extension 33 toward the housing space 330. In the exemplary embodiment, the engagement piece 41 obliquely projects from the inner side of the extension 33 toward the receiving portion 35 or the fixation portion 32 and has a distal end 411 that is to be engaged with the engaged portion 22 of the male member 20. The distal end of the engagement piece 41 is located closer to the fixation portion 32 than a distal end of the receiving portion 35. The engagement piece 41, which is integrally continuous with the extension 33, exhibits flexibility to a certain extent. Thus, in inserting the male member 20 into the female member 30, the engagement piece 41 is pushed by the engaging portion 22 to be slightly bent with a distance to the receiving portion 35 increased, which facilitates the insertion of the male member 20. On the other hand, when pulling force is applied to the male member 20 in the engaged state in which the distal end 411 of the engagement piece 41 is engaged with the engaged portion 22 of the male member 20, the engagement piece 41 is bent with the distance to the receiving portion 35 narrowed. This causes the engagement piece 41 and the engaged portion 22 to be more deeply engaged (increases an engagement allowance between the engagement piece 41 and the engaged portion 22), which may enhance the engagement strength.

### Incorporation Procedure

Description will be made on an incorporation procedure for fastening the cover material 5 to the cover material 3 using the above seat fastener 10.

First, the fixation portion 32 of the female member 30 is fixed to the peripheral portion 3A of the cover material 3 at the fixation position P1 by sewing the fixation portion 32 onto a first surface 3B as illustrated in FIG. 4. Likewise, the extended portion 262 of the tape member 26 of the male member 20 is fixed to the peripheral portion 5A of the cover material 5 at the fixation position P2 by being sewed onto the first surface 5B as illustrated in FIG. 3.

Here, each of the male member 20 and the female member 30 is continuously formed to have the same cross-sectional shape in the X-axis direction, no failure in engagement occurs even if engagement positions of the male member 20 and the female member 30 are misaligned in the X-axis direction to a certain extent. This makes it possible to eliminate the necessity of positioning the male member 20 and the female member 30 to each other in manufacturing each of the male member 20 and the female member 30 or in sewing the male member 20 and the female member 30 onto the cover materials 3 and 5.

For the above reason, even in a case where the male member 20 is manufactured and sewed onto the cover material 5 in a factory, while the female member 30 is manufactured and sewed onto the cover material 3 in another factory different from the above factory, it is possible to favorably engage the male member 20 and the female member 30 with each other. The seat fastener 10 of the exemplary embodiment thus has no failure in engagement or the like due to position misalignment that may be caused, for instance, in a case where a zipper with right and left element arrays each including a plurality of elements (zip teeth) arranged side by side in the X-axis direction is used and the right and left element arrays are misaligned in the X-axis direction (pitch misalignment).

In addition, in the seat fastener 10 of the exemplary embodiment, each of the male member 20 and the female member 30 is continuously formed in the X-axis direction without any slit or the like extending in a direction orthogonal to the X-axis direction, which makes it possible to reduce the time and effort for engaging the male member 20 with the female member 30 as compared with, for instance, a case where the above slit or the like is provided.

In a case where the peripheral portion 5A of the cover material 5 is not folded, the extended portion 262 of the tape member 26 of the male member 20 is located near an edge 511 of the peripheral portion 5A of the cover material 5 with respect to the male member body 21, and the engaged portion 22 of the male member body 21 is located at a position closer to the first surface 5B of the cover material 5 than the secured portion 261 of the tape member 26.

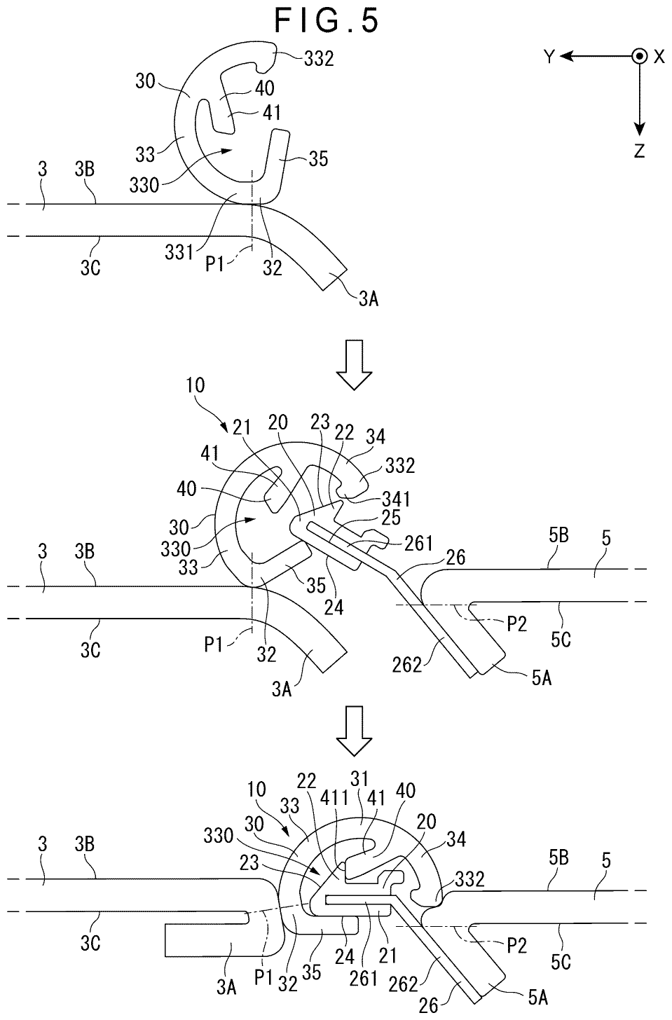

Next, as illustrated in FIG. 5, with the cover material 5 placed at a predetermined position to cover the seat body 2, the female member 30 is tilted with respect to the first surface 3B as the peripheral portion 3A of the cover material 3 is folded toward a second surface 3C. Meanwhile, as illustrated in FIG. 5, with the cover material 5 placed at a position facing the fixation position P1 of the female member 30 to the cover material 3, the male member body 21 is placed closer to the cover material 3 than the cover material 5 as the peripheral portion 5A fixed with the extended portion 262 of the tape member 26 is folded toward an second surface 5C of the cover material 5 and the engaged portion 22 of the male member body 21 is placed outside in the Z-axis direction with respect to the secured portion 261 of the tape member 26.

Subsequently, the male member body 21 is inserted into between the distal end 332 and the receiving portion 35 of the female member 30. At this time, the engaged portion 22 is placed at a position facing the extension 33 in the X-axis direction. Further, the male member 20 is inserted into the female member 30 while the inclined surface 23 of the male member body 21 is being guided by the engagement piece 41, until the engaged portion 22 reaches a position closer to the fixation portion 32 (near the cover material 3) than the engagement piece 41. The engaged portion 22 is thus brought into engagement with the engagement piece 41. At this time, an engagement surface of the distal end 411 of the engagement piece 41 and an engaged surface of the engaged portion 22 of the male member 20 are placed along the Z-axis direction so that they are inseparably engaged with each other in the Y-axis direction. The received surface 24 of the male member body 21 is received by the receiving portion 35 of the female member 30 to maintain the engaged state of the engaged portion 22 and the engagement piece 41.

In the engaged state, the respective fixation positions P1 and P2 in the cover materials 3 and 5 are opposed to each other in the Y-axis direction, the female member 30 is located between the cover materials 3 and 5, and the engagement portion 40 is located closer to the fixation position P2 than the fixation position P1 in the exemplary embodiment. The thus-located extension 33 of the female member 30 covers, from outside in the Z-axis direction, the whole of the male member body 21 and a portion of the extended portion 262 of the tape member 26 not sewed on the peripheral portion 5A of the cover material 5, and the extension 33 is exposed outside with respect to the cover materials 3 and 5 between the fixation positions P1 and P2 to the respective cover materials 3 and 5, with the male member body 21 being fully housed in the housing space 330. Further, a portion of the extended portion 262 sewed on the peripheral portion 5A and closer to the periphery than the fixation position P2 is folded toward the second surface 5C of the cover material 5, and thus not exposed on the first surface 5B. Further, in the engaged state, the distal end 332 of the extension 33 of the female member 30 is in contact with or able to come into contact with the first surface 5B of the cover material 5, and the receiving portion 35 is opposed to the extension 33 located outside in the Z-axis direction. The seat fastener 10 is configured to have a slight space formed between the main piece 31 and the male member 20 in the above engaged state, which facilitates insertion of the male member 20 into the female member 30 and engagement therebetween.

The seat fastener 10 is incorporated in this manner to fasten the cover material 5 to the cover material 3. In a fastened state, only the extension 33 of the female member 30 of the seat fastener 10 is exposed outside between the cover materials 3 and 5. It is thus possible to easily decorate the portion between the cover materials 3 and 5 by applying coloring, coating, lamination, or the like as desired to at least the extension 33. It should be noted that even in a case where lamination or the like is applied to the extension 33 as described above, the extension 33 itself is exposed outside. The female member 30, which is allowed to be misaligned in the X-axis direction to a certain extent with respect to the male member 20, is not necessarily required to be sewed along with the male member 20 onto the cover materials 3 and 5 with positioning in the same factory. It is thus possible to manufacture and sew different types of female members 30 with various decorations in other factories different from a factory for manufacturing and sewing the male member 20, making it possible to select the female member 30 to be used from among the different types of the female members 30 and increase variations in decoration for the portion between the cover materials 3 and 5.

### Modifications

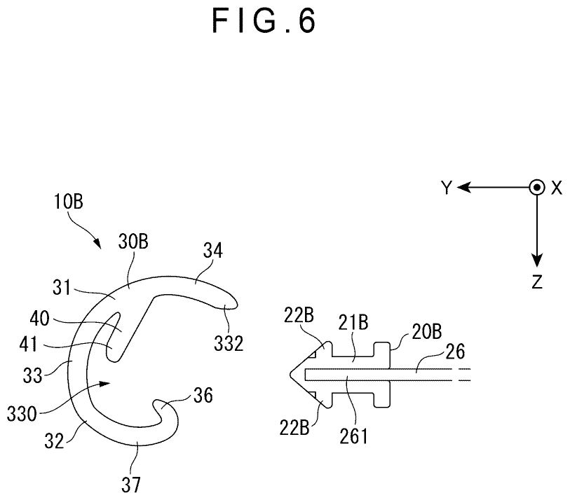

In the above exemplary embodiment, the female member 30 of the seat fastener 10 includes the engagement piece 41 and the receiving portion 35, and the engagement piece 41 is engaged with the engaged portion 22 of the male member body 21 in a form of a one-sided claw with the received surface 24 of the male member body 21 received by the receiving portion 35. The invention, however, is not limited thereto. For instance, as illustrated in a modification of FIG. 6, a seat fastener 10B may include a female member 30B that is to be engaged with a male member body 21B in a form of a double-sided claw.

The male member body 21B includes a pair of engaged portions 22B opposed in the Z-axis direction with the secured portion 261 of the tape member 26 in between and is thus substantially in a form of an arrowhead.

The female member 30B includes, in place of the receiving portion 35 continuous with the fixation portion 32, an engagement projection 36 that is opposed to the engagement piece 41 continuous with the inner side of the extension 33. The engagement projection 36, which is formed at a distal end of a piece 37 that extends continuously from the fixation portion 32, projects toward the engagement piece 41.

In the seat fastener 10B, the male member body 21B is inserted into the female member 30B with the pair of engaged portions 22B engaged with the engagement piece 41 and the engagement projection 36 of the female member 30B.

The male member 20B including the male member body 21B and the female member 30B are thus in the engaged state.

In the above exemplary embodiment, each of the male member 20 and the female member 30 is continuously formed in the longitudinal direction to have the same cross-sectional shape. The invention, however, is not limited thereto. For instance, a plurality of slits extending in a direction orthogonal to the X-axis direction may be provided in one or both of the male member 20 and the female member 30.

In the above exemplary embodiment, the extension 33 is formed in a curved shape in cross section. The invention, however, is not limited thereto, and it is only required that the main piece 31 is exposed outside between the cover materials 3 and 5. The extension 33 may thus have any other shape, such as a rectangle and a combined shape of a rectangle and a curve, as appropriate in accordance with a desired design.

In the above exemplary embodiment, the above engagement portion 40 is formed inside the extension 33. The invention, however, is not limited thereto. The engagement portion 40 may be formed at a position different from the extension 33 as long as the engagement portion 40 is engageable with the male member 20.

In the above exemplary embodiment, the extension 33 includes the projecting portion 34 that extends, in the engaged state, closer to the cover material 5 with respect to the continuous portion with the engagement portion 40. The invention, however, is not limited thereto. For instance, when there is no need to cover the male member 20 with a portion of the extension 33 ahead of the portion continuous with the engagement portion 40, the projecting portion 34 may be omitted. In this case, the distal end 332 of the extension 33 is located at a position where the distal end 332 is not in contact with the cover material 5. Further, even when the extension 33 includes the projecting portion 34, the distal end 332 may be located at a position where the distal end 332 is not in contact with the cover material 5.

In the above exemplary embodiment, the engagement portion 40 includes the engagement piece 41 that obliquely projects from the inner side of the extension 33 toward the fixation portion 32. The invention, however, is not limited thereto. For instance, an engagement piece that projects from the inner side of the extension 33 along the Z-axis direction is acceptable as long as being engageable with the engaged portion 22 of the male member 20.

In the above exemplary embodiment, the male member body 21 has the thickness smaller than the width as described above and is to be laid flat in the Y-axis direction in the engaged state. The invention, however, is not limited thereto. The male member body 21 may be formed in a dimensional relationship different from the above dimensional relationship as long as being engageable with the female member 30.

In the above exemplary embodiment, the tape member 26 of the male member 20 is formed from unwoven fabric. The invention, however, is not limited thereto. It is only required that the tape member 26 exhibits flexibility as described above, and the tape member 26 may be, for instance, fabric woven from yarns or a bendable seat material.

In the above exemplary embodiment, the female member 30 is formed from a softer material than the male member 20. The invention, however, is not limited thereto. For instance, the female member 30 may be formed from the same material as the male member 20 or the male member 20 may be formed from a softer material than the female member 30.

In the above exemplary embodiment, the female member 30 and the male member 20 are fixed to the respective cover materials 3 and 5 by sewing. The invention, however, is not limited thereto. The female member 30 and the male member 20 may be fixed, for instance, by bonding as long as a sufficient fixation strength is obtainable.

In the above exemplary embodiment, it is described that the female member 30 is fixed to the cover material 3 and the male member 20 is fixed to the cover material 5. However, contrary to the above, the female member 30 may be fixed to the cover material 5 and the male member 20 may be fixed to the cover material 3. In this case, the cover material 5 corresponds to the first seat member and the cover material 3 corresponds to a second seat member.

In the exemplary embodiment, it is described that the seat fastener 10 joins the cover materials 3 and 5, which are seat covers for the automobile seat 1. However, in addition to the above, the seat fastener 10 may join seat members for seats of aircraft, ship, or the like, seats for use in school or office building, exercise equipment, furniture such as residential sofa and bed, bags, clothing, erection structures such as a tent, packages for transportation, and the like.

### Effects of the Exemplary Embodiment

(1) The seat fastener 10, 10B of the exemplary embodiment is long and configured to fasten the cover material 5 to the cover material 3. The seat fastener 10, 10B includes the female member 30, 30B configured to be fixed to the cover material 3 and the male member 20, 20B configured to be fixed to the cover material 5. The female member 30, 30B includes the main piece 31 and the engagement portion 40 formed inside the main piece 31 to be engageable with the male member 20, 20B. The main piece 31 is configured to be located to cover at least a part of the male member 20, 20B from outside and the female member 30, 30B is configured to be at least partially exposed outside with respect to the cover materials 3 and 5 between the respective fixation positions P1 and P2 to the cover materials 3 and 5. The cover material 5 is thus fastened to the cover material 3 by engaging the male member 20, 20B with the engagement portion 40 of the female member 30, 30B. At this time, the main piece 31 is located to cover at least a part of the male member 20, 20B in the engaged state and exposed outside with respect to the cover materials 3 and 5 between the above fixation positions P1 and P2. It is thus possible to use at least a part of the main piece 31 as a decorative member between the cover material 3 and the cover material 5. In addition, since it is not necessary to use any other member than the seat fastener 10, 10B for decoration, it is possible to eliminate concerns about an increase in cost due to the addition of any other member and complication of an effort for incorporation.

(2) The main piece 31 includes the fixation portion 32 configured to be fixed to the cover material 3 and the extension 33 extending continuously from the fixation portion 32. The extension 33 has the housing space 330 defined inside thereof, opposite a surface exposed outside, to house a part of the male member 20, 20B. The engagement portion 40 is formed in the housing space 330. Thus, at least a part of the male member 20, 20B engaged with the engagement portion 40 formed in the housing space 330 is covered from outside by the extension 33, which makes it possible to decorate the extension 33 between the cover material 3 and the cover material 5.

(3) The outer surface of the extension 33 is at least partially curved. This makes it possible to improve the flexibility of the seat fastener itself as compared with, for instance, a case where the portion continuous with the fixation portion 32 is in a cornered shape such as a U-shape. Thus, even though a fastened portion is in a curved shape, the seat fastener 10, 10B is easily deformable in a curve to be fixed. It is thus possible to eliminate the necessity of a plurality of slits or the like along the Y-axis direction that may be provided to improve the flexibility of the seat fastener 10, 10B.

(4) The engagement portion 40 includes the engagement piece 41 projecting from the inner side of the extension 33 toward the housing space 330, the extension 33 includes the projecting portion 34 that extends closer to the fixation position P2 to the cover material 5 with respect to the continuous portion with the engagement portion 40, and the distal end 332 of the projecting portion 34 is in contact with the cover material 5 in the engaged state. This allows the male member 20, 20B to be broadly covered by the extension 33 with the distal end 332 of the projecting portion 34 being in contact with the cover material 5 in the engaged state of the female member 30, 30B and the male member 20, 20B. The design of appearance can thus be improved even though, for instance, the male member 20 or 20B is not decorated. In addition, the distal end 332 of the projecting portion 34 is in contact with the cover material 5, making it possible to stabilize the engaged state of the female member 30, 30B and the male member 20, 20B.

(5) The engagement portion 40 includes the engagement piece 41 projecting from the inner side of the extension 33 toward the housing space 330, the male member 20 includes the engaged portion 22 configured to be engaged with the distal end 411 of the engagement piece 41, the fixation portion 32 includes the receiving portion 35 continuous with a portion opposite the continuous portion with the extension 33, and the receiving portion 35 receives the male member 20 in the engaged state at the side opposite the engaged portion 22. In this configuration, the engagement piece 41 is temporarily deformed and bent as the male member 20 is inserted into the female member 30 while being received by the receiving portion 35. This facilitates engagement of the engaged portion 22 of the male member 20 with the distal end 411 of the engagement piece 41. Meanwhile, in the engaged state, the engagement piece 41 may function as a “barb” to prevent the male member 20 from being pulled out of the female member 30. Further, even when the male member 20 is attempted to be pulled out of the female member 30, force causing the distal end 411 to approach the male member 20 may act on the engagement piece 41. This may narrow a distance between the engagement piece 41 and the receiving portion 35 and further enhance the engagement strength.

(6) In the seat fastener 10B according to the modification illustrated in FIG. 6 of the exemplary embodiment, the engagement portion 40 includes the engagement piece 41 projecting from the inner side of the extension 33 and the engagement projection 36 continuous with the fixation portion 32 and located at a position facing the engagement piece 41, and the male member 20B includes the pair of engaged portions 22B configured to be engaged with the engagement piece 41 and the engagement projection 36. The engagement strength is improvable by the engagement of the pair of engaged portions 22B of the male member 20B with the engagement piece 41 and the engagement projection 36.

(7) The male member 20, 20B includes the male member body 21, 21B that is long and flexible and that includes the engaged portion 22, 22B configured to be engaged with the engagement portion 40, and the tape member 26 attached to the male member body 21 or 21B, which is a tape member. The thickness of the male member body 21, 21B, excluding the engaged portion 22, 22B, in the Z-axis direction is smaller than the width thereof in the Y-axis direction. The male member body 21, 21B is thus formed to have substantially a flat shape, and the male member body 21, 21B formed, for instance, from a rigid resin can have flexibility. In addition, the tape member 26 attached to the male member body 21, 21B is easily fixable to the cover material 5 by being sewed or the like onto the exterior side (the first surface 5B). The tape member 26 fixed may be prevented from being exposed on the exterior side by folding the portion of the cover material 5 to which the tape member 26 is fixed.

(8) The female member 30, 30B is formed from a softer material than the male member 20, 20B. Thus, the flexibility of the seat fastener 10, 10B as a whole may be improved by forming the female member 30, 30B from a soft material while the engagement strength between the male member 20, 20B and the engagement portion 40 is maintained.

(9) The incorporation method of the exemplary embodiment is an incorporation method of fastening the cover material 5 to the cover material 3 using the long seat fastener 10, 10B. The seat fastener 10, 10B includes: the female member 30, 30B including the main piece 31 and the engagement portion 40 formed inside the main piece 31; and the male member 20, 20B engageable with the engagement portion 40. The incorporation method includes: fixing the female member 30, 30B to the cover material 3 and fixing the male member 20, 20B to the cover material 5; and engaging the male member 20, 20B with the engagement portion 40. In the engaged state in which the male member 20, 20B is engaged with the engagement portion 40, the main piece 31 is located to cover at least a part of the male member 20, 20B from outside and is exposed outside with respect to the cover materials 3 and 5 between the respective fixation positions P1 and P2 to the cover materials 3 and 5. It is thus possible to provide the incorporation method that may achieve workings and effects similar to those of the above seat fastener 10, 10B of the exemplary embodiment.

What is claimed is:

1. A long seat fastener configured to fasten a second seat member to a first seat member, the seat fastener comprising:
a female member configured to be fixed to the first seat member; and
a male member configured to be fixed to the second seat member, wherein
the female member comprises: a main piece; and an engagement portion formed inside the main piece to be engageable with the male member, and
in an engaged state in which the male member is engaged with the engagement portion, the main piece is located to cover at least a part of the male member from outside and is exposed outside with respect to the first seat member and the second seat member between respective fixation positions to the first seat member and the second seat member.

2. The seat fastener according to claim 1, wherein
the main piece comprises: a fixation portion configured to be fixed to the first seat member; and an extension extending continuously from the fixation portion,
the extension has a housing space defined inside thereof, opposite a surface exposed outside, to house a part of the male member, and
the engagement portion is formed in the housing space.

3. The seat fastener according to claim 2, wherein an outer surface of the extension is at least partially curved.

4. The seat fastener according to claim 2, wherein
the engagement portion comprises an engagement piece projecting from an inner side of the extension toward the housing space, and the extension comprises a projecting portion that extends closer to the fixation position to the second seat member with respect to a continuous portion with the engagement portion, and
a distal end of the projecting portion is in contact with the second seat member in the engaged state.

5. The seat fastener according to claim 2, wherein
the engagement portion comprises an engagement piece projecting from an inner side of the extension toward the housing space,
the male member comprises an engaged portion configured to be engaged with a distal end of the engagement piece,
the fixation portion comprises a receiving portion continuous with a portion opposite a continuous portion with the extension, and
the receiving portion is configured to receive the male member in the engaged state at a side opposite the engaged portion.

6. The seat fastener according to claim 2, wherein
the engagement portion comprises: an engagement piece projecting from an inner side of the extension; and an engagement projection continuous with the fixation portion, the engagement projection being located at a position facing the engagement piece, and
the male member comprises a pair of engaged portions configured to be engaged with the engagement piece and the engagement projection.

7. The seat fastener according to claim 1, wherein
the male member comprises: a male member body that is long and flexible and that comprises an engaged portion configured to be engaged with the engagement portion; and a tape member attached to the male member body, and
a thickness of the male member body, excluding the engaged portion, in a thickness direction orthogonal to a longitudinal direction of the male member body is smaller than a width of the male member body in a width direction orthogonal to the longitudinal direction and the thickness direction.

8. The seat fastener according to claim 1, wherein the female member is formed from a softer material than the male member.

9. An incorporation method of fastening a second seat member to a first seat member using a long seat fastener, the seat fastener comprising: a female member comprising a main piece and an engagement portion formed inside the main piece; and a male member engageable with the engagement portion, the method comprising:
fixing the female member to the first seat member and fixing the male member to the second seat member; and
engaging the male member with the engagement portion, wherein
in an engaged state in which the male member is engaged with the engagement portion, the main piece is located to cover at least a part of the male member from outside and is exposed outside with respect to the first seat member and the second seat member between respective fixation positions to the first seat member and the second seat member.
